(19) United States
(12) Patent Application Publication
(10) Pub. No.: US 2026/0084054 A1
(43) Pub. Date: Mar. 26, 2026

(54) PROMPT INFORMATION DISPLAY METHOD AND APPARATUS, DEVICE, AND STORAGE MEDIUM

(71) Applicant: Tencent Technology (Shenzhen) Company Limited, Shenzhen (CN)

(72) Inventor: Huifei BAO, Shenzhen (CN)

(21) Appl. No.: 19/374,819

(22) Filed: Oct. 30, 2025

Related U.S. Application Data
(63) Continuation of application No. PCT/CN2024/086831, filed on Apr. 9, 2024.

(30) Foreign Application Priority Data
Jun. 15, 2023 (CN) 202310713079.1

(51) Int. Cl. A63F 13/533; A63F 13/537

(52) U.S. Cl. CPC A63F 13/533; A63F 13/537

(57) ABSTRACT

A prompt information display method is performed by a computer device. The method includes: displaying a picture of a virtual environment, and the virtual environment comprising the first virtual object and at least one second virtual object; and updating the virtual environment picture with alert prompt information of the second virtual object for the first virtual object, the alert prompt information being configured for indicating an alert state type and an alert state progress of the second virtual object, the alert state progress being configured for controlling switching between different alert state types indicating different reactions of the second virtual object to the first virtual object. The foregoing method can enable a user to quickly obtain and learn a state change of a virtual object, thereby improving information obtaining efficiency, and further improving human-computer interaction efficiency.

### CROSS-REFERENCE TO RELATED APPLICATIONS

This application is a continuation application of PCT Patent Application No. PCT/CN2024/086831, entitled “PROMPT INFORMATION DISPLAY METHOD AND APPARATUS, DEVICE, AND STORAGE MEDIUM” filed on Apr. 9, 2024, which claims priority to Chinese Patent Application No. 202310713079.1, entitled "PROMPT INFORMATION DISPLAY METHOD AND APPARATUS, DEVICE, AND STORAGE MEDIUM" filed on Jun. 15, 2023, both of which are incorporated herein by reference in their entirety.

### FIELD OF THE TECHNOLOGY

Embodiments of this application relate to the field of computer technologies, and in particular, to a prompt information display method and apparatus, a device, and a storage medium.

### BACKGROUND OF THE DISCLOSURE

In a game application, some virtual objects controlled by a server are generally provided, and are also referred to as artificial intelligence (AI) virtual objects. To ensure gaming experience of a user, the game application usually provides some prompt information for the user for the AI virtual objects, to inform the user of information such as attributes of the AI virtual objects.

In a multiplayer online battle arena (MOBA) game, in the related art, for an AI virtual object in an enemy camp in a game match, a health bar color different from that of a virtual object of an ally camp is used for prompting. The health bar color refers to a color of a health bar, and the health bar is configured for indicating health points of a virtual object. For example, a health bar color of an enemy AI virtual object is red, and a health bar color of an ally virtual object is blue, to prompt the ally virtual object that the enemy AI virtual object belongs to an enemy camp.

However, in the related art, the health bar color is simply used for information prompts, resulting in limited content diversity of prompt information, which is not conducive to human-computer interaction.

### SUMMARY

Embodiments of this application provide a prompt information display method and apparatus, a device, and a storage medium. The technical solutions are as follows.

According to an aspect of the embodiments of this application, a prompt information display method is performed by a terminal device, and includes:

displaying a picture of a virtual environment, and the virtual environment comprising the first virtual object and at least one second virtual object; and

updating the virtual environment picture with alert prompt information of the second virtual object for the first virtual object, the alert prompt information being configured for indicating an alert state type and an alert state progress of the second virtual object, the alert state progress being configured for controlling switching between different alert state types indicating different reactions of the second virtual object to the first virtual object.

According to an aspect of the embodiments of this application, a computer device is provided. The computer device includes a processor and a memory, the memory has a computer program stored therein, and the computer program is loaded and executed by the processor to implement the foregoing method.

According to an aspect of the embodiments of this application, a non-transitory computer-readable storage medium is provided. The readable storage medium has a computer program stored therein, and the computer program is loaded and executed by a processor of a computer device and causes the computer device to implement the foregoing method.

According to an aspect of the embodiments of this application, a computer program product is provided. The computer program product includes a computer program. The computer program is stored in a non-transitory computer-readable storage medium. A processor of a computer device reads the computer program from the computer-readable storage medium, and executes the computer program, to cause the terminal device to perform the foregoing method.

The technical solutions provided in the embodiments of this application have at least the following beneficial effects.

Alert prompt information of a second virtual object (for example, an AI virtual object) for a first virtual object is displayed in a virtual environment picture, so that a user can quickly obtain and learn an alert state type of the second virtual object and an alert state progress of the second virtual object that are indicated by the alert prompt information, thereby improving information obtaining volume and efficiency. The user can learn in advance, based on the alert state progress, whether the second virtual object is about to switch to another alert state type, so that the user can quickly obtain and learn a state change of a virtual object, to adaptively take a preventive measure in advance, thereby improving human-computer interaction efficiency.

### BRIEF DESCRIPTION OF THE DRAWINGS

FIG. 1 is a schematic diagram of a solution implementation environment according to an embodiment of this application.

FIG. 2 is a schematic diagram of prompt information in the related art.

FIG. 3 is a flowchart of a prompt information display method according to an embodiment of this application.

FIG. 4 is a schematic diagram of a field of view according to an embodiment of this application.

FIG. 5 is a schematic diagram of alert prompt information according to an embodiment of this application.

FIG. 6 is a schematic diagram of alert prompt information according to another embodiment of this application.

FIG. 7 is a schematic diagram of alert prompt information according to another embodiment of this application.

FIG. 8 is a flowchart of a prompt information display method according to another embodiment of this application.

FIG. 9 is a schematic diagram of first prompt information according to an embodiment of this application.

FIG. 10 is a schematic diagram of an azimuth calculation method according to an embodiment of this application.

FIG. 11 is a schematic diagram of first prompt information according to another embodiment of this application.

FIG. 12 is a schematic diagram of alert state rollback according to an embodiment of this application.

FIG. 13 is a flowchart of a prompt information display method according to another embodiment of this application.

FIG. 14 is a schematic diagram of second prompt information according to an embodiment of this application.

FIG. 15 is a flowchart of a prompt information display method according to another embodiment of this application.

FIG. 16 is a block diagram of a prompt information display method according to an embodiment of this application.

FIG. 17 is a block diagram of a prompt information display method according to another embodiment of this application.

FIG. 18 is a block diagram of a prompt information display apparatus according to an embodiment of this application.

FIG. 19 is a block diagram of a terminal device according to an embodiment of this application.

### DESCRIPTION OF EMBODIMENTS

To make the objectives, technical solutions, and advantages of this application clearer, the following further describes the implementations of this application in detail with reference to the accompanying drawings.

First, terms involved in the embodiments of this application are briefly introduced. The following terms and explanations may be combined with the technical solutions of the embodiments of this application in different manners as exemplary solutions, and all of them fall within the protection scope of the embodiments of this application. The embodiments of this application include at least a part of the following content.

Enemy alert information (alert prompt information): It is prompt information generated by an AI mechanism of an enemy (where the enemy may be another virtual character relative to a virtual character controlled by a user, for example, an AI virtual object belonging to an enemy camp, a virtual object controlled by another user, or an AI virtual object in a neutral camp) in a game application. The AI mechanism can control the enemy to enter a specific alert state in a particular situation (for example, a first virtual object controlled by the user passes by the enemy, the first virtual object kills another virtual object, or the enemy is attacked by the first virtual object), and control the enemy to make different reactive reactions for different situations based on the alert state. For example, the enemy in a normal state does not actively attack, but in an alert state, the enemy initiates an active attack.

Multiplayer mode: The multiplayer mode is a game match mode.in which a user may play with other remote users, compete against each other, engage in gameplay together, or the like.

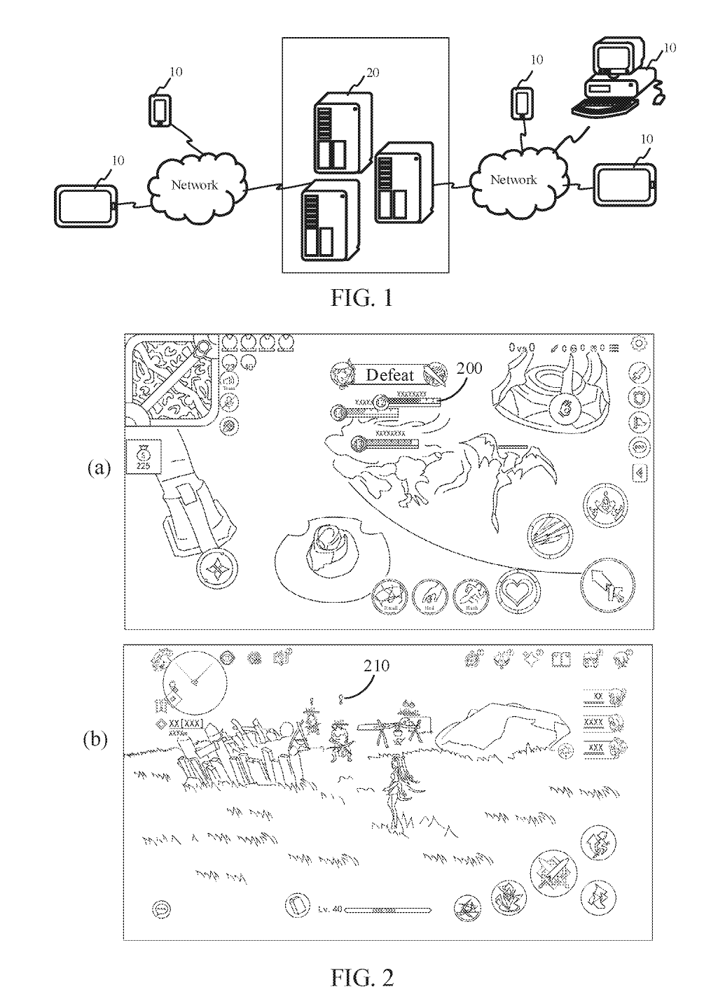

FIG. 1 is a schematic diagram of a solution implementation environment according to an embodiment of this application. The solution implementation environment may include: a terminal device 10 and a server 20.

The terminal device 10 includes, but is not limited to, electronic devices such as a mobile phone, a tablet computer, an intelligent voice interaction device, a game console, a wearable device, a multimedia playback device, a personal computer (PC), an in-vehicle terminal, and an intelligent appliance. A client of a target application (for example, a game application) may be installed in the terminal device 10. In some embodiments, the target application may be an application that needs to be downloaded and installed or may be a click-to-use application, the target application may be an online application or may be an offline application, and the target application may be a PC application or may be a mobile application. This is not limited in this embodiment of this application.

In this embodiment of this application, the target application may include at least one of the following: a simulation program, a battle royale shooting game, a virtual reality (VR) application, an augmented reality (AR) program, a three-dimensional map program, a virtual reality game, an augmented reality game, a first-person shooting (FPS) game, a multiplayer shooting survival game, a third-person shooting (TPS) game, a MOBA game, a simulation game (SLG), a social application, or an interactive entertainment application. In this embodiment of this application, an example in which the target application is a game application is used for description. A game match exists in the game application, different prompt information exists for different AI virtual objects in different game matches, and the prompt information is information configured for prompting a user. In some embodiments, a client of the game application is run on the terminal device 10.

In this embodiment of this application, a virtual environment is a scene displayed (or provided) when the client of the target application (for example, a game application) is run on the terminal device. The virtual environment is an environment created for a virtual object to perform activities (for example, game competitions), such as a virtual house, a virtual island, or a virtual map. In some embodiments, the virtual environment is an environment displayed (or provided) when an application is run in a terminal device. The virtual environment may be a simulated world of the real world, a semi-simulated and semi-fictional three-dimensional world, or a purely fictional three-dimensional world. The virtual environment may be any one of a two-dimensional virtual environment, a 2.5-dimensional virtual environment, or a three-dimensional virtual environment. In some embodiments, the virtual environment may be further configured for battles between at least two virtual objects. The virtual environment has virtual resources available for use by the at least two virtual objects.

The virtual object is a virtual character, a virtual vehicle, a virtual item, or the like controlled by a user account in the target application. This is not limited in this embodiment of this application. That the target application is the game application is used as an example. The virtual object is a virtual character controlled by a user account in the game application. The virtual object may be in a form of a human, an animal, or a cartoon, or may be in other forms. This is not limited in this embodiment of this application. The virtual object may be presented in a three-dimensional form or in a two-dimensional form. This is not limited in this embodiment of this application. In some embodiments, when the virtual environment is a three-dimensional virtual environment, the virtual object is a three-dimensional model created based on a skeletal animation technology. Each virtual object has a shape and a volume in the three-dimensional virtual environment, and occupies a part of space in the three-dimensional virtual environment. Activities of the virtual object include at least one of the following: adjusting body postures, crawling, walking, running, riding, flying, jumping, driving, picking, shooting, attacking, or throwing. For example, the virtual object is a virtual person such as a simulated person character or a cartoon person character. In some implementations, the virtual object may alternatively be implemented by using a 2.5- dimensional model or a two-dimensional model. This is not limited in this embodiment of this application.

In an example, according to different manners of controlling the virtual objects, the virtual objects may be divided into a virtual object controlled by a user and a virtual object controlled by a server. The virtual object controlled by a user is an object that may be controlled by the client and that is movable in the virtual environment. The virtual object controlled by a server is a virtual object controlled by an automatic control algorithm or an artificial intelligence program on the client or the server. The virtual object controlled by a server includes a movable object and an unmovable object in the virtual environment. For example, a first virtual object in this embodiment of this application is a virtual object controlled by a client, and a second virtual object in this embodiment of this application is a virtual object controlled by a server. Certainly, the second virtual object in this embodiment of this application may alternatively be a virtual object controlled by the client. This is not limited in this embodiment of this application.

The server 20 is configured to provide a backend service for the client of the target application installed and run in the terminal device 10. For example, the server 20 may be an independent physical server, may be a server cluster or a distributed system formed by a plurality of physical servers, or may be a cloud server that provides a basic cloud computing service such as a cloud service, a cloud database, cloud computing, a cloud function, cloud storage, a network service, cloud communication, a middleware service, a domain name service, a security service, a content delivery network (CDN), big data, and an artificial intelligence platform, but is not limited thereto.

In the following embodiments, an example in which a first virtual object is a virtual object controlled by a client, a second virtual object is a virtual object controlled by a server, and a third virtual object is a virtual object controlled by a client is used for description. In some embodiments, the terminal device 10 includes a first terminal device and a second terminal device. The first terminal device is installed with a first client of the target application, and the second terminal device is installed with a second client of the target application. A first user account of a first user may be configured for controlling the first virtual object in the first client of the target application, and a second user account of a second user may be configured for controlling the third virtual object in the second client of the target application. In some embodiments, the first virtual object and the third virtual object may have a friend relationship or a teammate relationship, have temporary communication permissions, or the like. The first virtual object and the third virtual object may also belong to the same camp, the same team, the same organization, or the like. This is not limited in this embodiment of this application. In some embodiments, the first virtual object and the third virtual object may alternatively not have a friend relationship, or belong to different camps, different teams, or different organizations. In some embodiments, the clients installed in the first terminal device and the second terminal device are the same, or the clients installed in the first terminal device and the second terminal device are clients of the same type on different operating system platforms (Android or iOS). The first terminal device may generally refer to one of a plurality of terminal devices, and the second terminal device may generally refer to another one of the plurality of terminal devices. In this embodiment of this application, the first terminal device and the second terminal device are merely used as an example for description. In some embodiments, the second virtual object controlled by the server and the first virtual object do not have a friend relationship, or belong to different camps, different teams, or different organizations. The second virtual object controlled by the server and the third virtual object do not have a friend relationship, or belong to different camps, different teams, or different organizations.

The terminal device 10 may communicate with the server 20 through a network. The network may be a wired network or a wireless network.

FIG. 2 is a schematic diagram of prompt information in the related art.

In the related art, appearance information (such as a color or a shape) of a name, a health bar, and the like of an AI virtual object is used to prompt a user whether the AI virtual object is in a hostile state or a friendly state. As shown in a sub-picture a of FIG. 2, in the related art, a color of a name located above the head of the AI virtual object or a color of a health bar 200 is used to distinguish whether an enemy is in a hostile state or a friendly state, without any prompt information related to an alert. The method can only distinguish an enemy and an ally from each other, but cannot identify a complex state of the enemy. Certainly, it is also possible that the enemy has no excessive states, with only a difference between a combat state and a non-combat state.

As shown in a sub-picture b of FIG. 2, in the related art, an exclamation mark 210 is added above the head of the enemy to prompt the user that the enemy enters the combat state. The exclamation mark 210 is only used as prompt information for state switching of the enemy, and the exclamation mark 210 disappears after state switching is completed. An exclamation mark animation effect triggered by satisfying a condition indicates a current state of the enemy, but only shows switching between states without providing information prompt of a change between states, and the user cannot learn when the enemy performs state switching.

Therefore, limited content diversity of the prompt information in the related art is caused, which is not conducive to human-computer interaction.

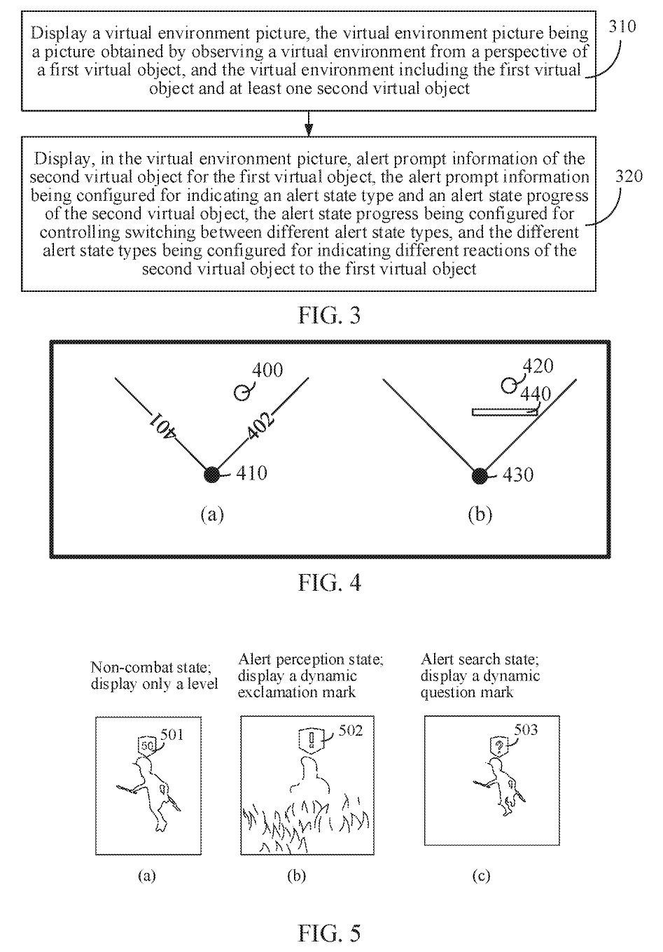

FIG. 3 is a flowchart of a prompt information display method according to an embodiment of this application. Operations of the method may be performed by the terminal device 10 in the solution implementation environment shown in FIG. 1. For example, the operations may be performed by the client of the foregoing target application. In the following method embodiments, for ease of description, an example in which the operations are performed by a "client" is used for description. The method may include at least one of the following several operations (310 and 320).

Operation 310: Display a virtual environment picture, the virtual environment picture being a picture obtained by observing a virtual environment from a perspective of a first virtual object, and the virtual environment including the first virtual object and at least one second virtual object.

Virtual environment: It is a virtual environment displayed (or provided) when the target application is run on the terminal device. The virtual environment may be any one of a two-dimensional virtual environment, a 2.5-dimensional virtual environment, or a three-dimensional virtual environment. The virtual environment may be a simulated world of the real world, a semi-simulated and semi-fictional three-dimensional world, or a purely fictional three-dimensional world. In some embodiments, the target application program provides at least one virtual environment. For example, using a game application as an example, the virtual environment may be a virtual environment provided by a game match, and a user may control a virtual object to battle in the virtual environment. The virtual environment picture may be displayed through a display screen of the terminal device.

A type of an object included in the virtual environment is not limited in this embodiment of this application. The first virtual object (which is a virtual object controlled by a first user account on a first client), the second virtual object (which is a virtual object controlled by a server, and may also be referred to as an AI virtual object), and a third virtual object (which is a virtual object controlled by a second user account on a second client) perform activities in the virtual environment.

In some embodiments, the first virtual object and the second virtual object have a hostile relationship, and two virtual objects in a hostile relationship may attack each other. For example, one game match provides two camps, and there is a competitive relationship between the two camps. If the first virtual object and the second virtual object belong to different camps, it can be determined that the first virtual object and the second virtual object are in the hostile relationship. The second virtual object may alternatively belong to a neutral camp, but when a specific condition is satisfied (for example, the first virtual object passes by the second virtual object, the first virtual object kills another virtual object, or the second virtual object is attacked by the first virtual object), a relationship between the second virtual object and the first virtual object switches to the hostile relationship, such as a creep or a non-player character (NPC) set in the virtual environment. The first virtual object and the second virtual object may alternatively be in a team relationship. This is not limited in this embodiment of this application.

In some embodiments, the first virtual object or the third virtual object may attack the second virtual object, and the second virtual object can also attack the first virtual object or the third virtual object. In some embodiments, when the first user controls the first virtual object to approach the second virtual object, it triggers an alert of the second virtual object for the first virtual object, and the first virtual object can see alert prompt information of the second virtual object for the first virtual object. In some embodiments, when the second user controls the third virtual object to approach the second virtual object, it also triggers an alert of the second virtual object for the third virtual object, and the third virtual object can also see alert prompt information of the second virtual object for the third virtual object.

Perspective of a first virtual object: It is a perspective of observing a virtual environment based on the first virtual object. The perspective of the first virtual object may be configured for determining a field of view of the first virtual object. A virtual environment within the field of view forms the virtual environment picture. In some embodiments, the perspective of the first virtual object is a first-person perspective of the first virtual object. For example, if a virtual camera is disposed on the head of the first virtual object, it may be considered that the head of the first virtual object is a position (that is, a start point of a perspective) of the virtual camera, and an orientation of the head of the first virtual object is an orientation of the virtual camera. In this case, a perspective of the virtual camera is considered as the perspective of the first virtual object, and the virtual camera is configured to simulate human eyes to observe the virtual environment.

In some embodiments, the perspective of the first virtual object may be a third-person perspective of the first virtual object. For example, if the virtual camera is disposed not at the head of the first virtual object (for example, at positions behind the head or behind the back), the virtual camera can capture the head of the first virtual object, and an orientation of the head of the first virtual object is an orientation of the virtual camera. In this case, a perspective of the virtual camera is considered as the perspective of the first virtual object.

In some embodiments, the perspective of the first virtual object is a perspective changing with a position of the first virtual object. In some embodiments, an orientation of the perspective of the first virtual object does not change with an orientation of the first virtual object, but a position of a virtual camera corresponding to the perspective of the first virtual object always changes with the position of the first virtual object. In some embodiments, the first virtual object is always displayed within the perspective of the first virtual object.

In some other embodiments, the perspective of the first virtual object is a perspective independent of the first virtual object in the virtual environment. For example, the perspective of the first virtual object is a perspective of a virtual camera at a specific position and with a specific orientation specified by the target application, and the position and the orientation of the virtual camera remain unchanged, that is, the perspective of the first virtual object remains unchanged.

In some embodiments, when the perspective of the first virtual object is a perspective related to the first virtual object in the virtual environment, the client rotates the perspective of the first virtual object in reaction to a first perspective rotation operation of the user. The first perspective rotation operation is an operation for rotating the perspective of the first virtual object. In some embodiments, an operation type of the first perspective rotation operation includes, but is not limited to, an operation such as clicking/tapping, sliding, or dragging. A specific operation type is not limited in this application. The operation in this embodiment of this application may be implemented by using the display screen of the terminal device, or may be implemented by using an external device (such as a mouse, a keyboard, a joystick, or a game controller) of the terminal device. This is not limited in this embodiment of this application.

In some embodiments, a picture obtained by observing the virtual environment from the perspective of the first virtual object is used as the virtual environment picture. In some embodiments, if the perspective of the first virtual object is a perspective of a virtual camera, a picture captured by the virtual camera is used as the virtual environment picture. In some embodiments, if the perspective of the first virtual object changes, the picture obtained by observing the virtual environment from the perspective of the first virtual object (that is, the virtual environment picture) also changes.

In some embodiments, the virtual environment picture is a real-time picture obtained by capturing the virtual environment. For example, because the virtual object controlled by the user account performs an activity in the virtual environment, it results in the virtual environment including the virtual object and an activity trace of the virtual object. In this case, the virtual environment picture is a picture presenting a real-time state of the virtual environment.

Operation 320: Display, in the virtual environment picture, alert prompt information of the second virtual object for the first virtual object, the alert prompt information being configured for indicating an alert state type and an alert state progress of the second virtual object, the alert state progress being configured for controlling switching between different alert state types, and the different alert state types being configured for indicating different reactions of the second virtual object to the first virtual object.

The alert prompt information is prompt information configured for indicating an alert state of a virtual object for another virtual object. The alert state refers to being in a state of vigilance, and a virtual object in the alert state is alerted to another virtual object. In this embodiment of this application, the alert prompt information is prompt information configured for indicating an alert state type and an alert state progress of the second virtual object. A specific presentation of the alert prompt information is not limited in this embodiment of this application. In some embodiments, the alert prompt information may be visual information for the alert state. For example, the alert prompt information may be in a form of a text, an image, or a value, to respectively indicate the alert state type and the alert state progress of the second virtual object. The alert state progress indicated by the alert prompt information is a progress of the alert state type indicated by the alert prompt information.

In some embodiments, the alert state in this embodiment of this application corresponds to a plurality of alert state types. The alert state type is a type of alert state. The second virtual object in different alert state types (that is, in different types of alert states) has different attribute values. For example, an attribute value of the second virtual object for a first alert state is a, and an attribute value of the second virtual object for a second alert state is b. The type of the first alert state is different from the type of the second alert state. A specific type of the alert state is not limited in this application, and an attribute of the second virtual object is also not limited in this application.

For example, the attribute of the second virtual object includes, but is not limited to, at least one of the following: a movement speed, an attack speed, an attack value, a defense value, a health value, a form of the second virtual object, a magic value, a hate value, a movement range, an attack skill, or the like. For example, for a process of the second virtual object moving from a stationary state to moving forward, it may be considered that being stationary and moving correspond to two alert state types. For example, for a process of the attack value of the second virtual object increasing from 100 to 200, it may be considered that an attack value of 100 and an attack value of 200 correspond to two alert state types. For example, for a process of skills of the second virtual object changing from a skill 1 and a skill 2 to a skill 3 and a skill 4, the second virtual object having the skill 1 and the skill 2 is considered to be in one type of alert state, and the second virtual object having the skill 3 and the skill 4 is considered to be in another type of alert state. In some embodiments, types included in alert states (namely, alert state types) may be set in advance by the developer of the application, or may be set by a user in a setting interface of the application. This is not limited in this embodiment of this application.

In some embodiments, the alert state progress is configured for indicating the alert progress of the second virtual object in the alert state type. The alert progress is progress of an alert state, and possibilities of switching from one alert state to another alert state (that is, the alert state type) in different alert progresses are different. For example, a higher alert state progress of an alert state type indicates a higher possibility of switching to another alert state type. When the alert state progress reaches a threshold, the second virtual object may directly switch from the alert state type to the another alert state type. In other words, the alert state progress can indicate to the user whether the second virtual object is about to switch from a current alert state type to a next alert state type, so that the user can quickly obtain and learn an alert state change of the second virtual object (namely, an enemy) based on the alert state progress, to take targeted measures, thereby improving information obtaining efficiency and human-computer interaction efficiency.

Because the second virtual object can switch between different types of alert states, the alert state progress is also an important indicator configured for indicating switching of the alert state type. In some embodiments, each alert state type corresponds to state progress increase and decrease conditions. The client may adjust the alert state progress by detecting whether a progress increase or decrease condition is satisfied. For example, when the progress increase condition is satisfied, the alert state progress increases, and when the progress increase condition is not satisfied or the progress decrease condition is satisfied, the alert state progress decreases. In some embodiments, different alert state types correspond to different progress increase conditions and different progress decrease conditions. In some embodiments, the server may determine the alert state of the second virtual object and the progress of the alert state based on operation data fed back by the client. The operation data may be data generated by an operation of a user.

For example, when the second virtual object is in an attack state (which is a type of alert state), if the first virtual object kills a virtual object controlled by the user each time, a progress of the attack state of the first virtual object increases. When a quantity of virtual objects killed by the first virtual object within a time threshold exceeds a kill threshold, it may be considered that the progress of the attack state is full (that is, the alert state progress reaches a maximum value), and the client needs to switch the second virtual object to a berserk state (which is another type of alert state). After the second virtual object switches from the alert state to the berserk state, attack power of the second virtual object is increased. When the quantity of virtual objects killed by the first virtual object within the time threshold does not satisfy the threshold, the progress of the attack state decreases (that is, the alert state progress decreases), until the progress of the attack state decreases to 0, and the second virtual object switches to another alert state, for example, a patrol state.

For another example, when the second virtual object is in the patrol state, if no virtual objects controlled by the user are detected, the client controls the second virtual object to remain in the patrol state, and a progress of the patrol state remains unchanged. If perceiving a virtual object controlled by the user, the client controls a state progress of the patrol state of the second virtual object to increase, and the second virtual object is switched to the attack state until the progress of the patrol state is full.

In some embodiments, the client displays the alert prompt information of the second virtual object within the field of view of the first virtual object. In other words, when the second virtual object is within the field of view of the first virtual object, the client displays the alert prompt information of the second virtual object. The field of view of the first virtual object corresponds to the perspective of the first virtual object. For example, the field of view of the first virtual object may be determined based on a position and an orientation of the perspective of the first virtual object. When a virtual camera is set, the field of view of the first virtual object may be considered as a capture range of the virtual camera.

As shown in a sub-picture a of FIG. 4, 410 in FIG. 4 is considered as the first virtual object. Certainly, 410 in FIG. 4 may alternatively be considered as the virtual camera. A field of view of the first virtual object 410 may alternatively be considered as a capture range (which is an acute angle area formed by a ray 401 and a ray 402) of the virtual camera. When a second virtual object 400 is within the field of view of the first virtual object 410, the client displays alert prompt information of the second virtual object 400. In some other embodiments, as shown in a sub-picture b of FIG. 4, a second virtual object 420 is still within the field of view of a first virtual object 430. However, due to blocking by an obstacle 440, the first virtual object 430 cannot directly see the second virtual object 420. In other words, the client cannot directly display the second virtual object 420 within the field of view of the first virtual object 430. In this case, the client may not directly display the second virtual object, but directly display the alert prompt information of the second virtual object. In some embodiments, not directly displaying the second virtual object may be implemented as: displaying an outline of the second virtual object, displaying a point of the second virtual object (for example, highlighting by using a dot), displaying a direction of the second virtual object, or the like. This is not limited in this embodiment of this application.

In some embodiments, the alert prompt information includes: type prompt information, configured for indicating the alert state type of the second virtual object; and progress prompt information, configured for indicating the alert state progress of the second virtual object. The type prompt information is prompt information corresponding to the alert state type, and the type prompt information may be displayed in a form of a text, a value, an icon, or the like. The progress prompt information is prompt information corresponding to the alert state progress, and the progress prompt information may be displayed in a form of a text, a value, an icon, or the like. This is not limited in this embodiment of this application. The type prompt information and the progress prompt information are used to distinguish between the alert state type and the alert state progress, so that alert state information is displayed more intuitively and regularly, helping the user to rapidly obtain the alert state type and the alert state progress, thereby further improving information obtaining efficiency.

In some embodiments, each alert state type corresponds to a state identifier. After determining the alert state type of the second virtual object, the client determines the state identifier corresponding to the alert state type, and displays the state identifier in the virtual environment picture. In some embodiments, different alert state types correspond to different state identifiers. For example, the alert state progress may be indicated in a form of a progress bar (which may be a continuous progress bar or discrete progress points). A form of the state identifier is not limited in this embodiment of this application.

For example, as shown in FIG. 5, the alert prompt information is displayed above the head of the second virtual object. The alert prompt information includes a state identifier (corresponding the type prompt information) corresponding to the alert state type, and a progress identifier (corresponding the progress prompt information, not shown in FIG. 5) corresponding to the alert state progress. As shown in a sub-picture a of FIG. 5, when the second virtual object is in a non-combat state, the client displays only a shield and a level in the shield (that is, a state identifier corresponding to the non-combat state). In this case, the shield and the level 501 in the shield are considered as type prompt information corresponding to the non-combat state. As shown in a sub-picture b of FIG. 5, when the second virtual object is in the alert perception state, the client displays a shield and an exclamation mark (that is, a state identifier corresponding to the alert perception state) in the shield. In this case, the shield and the exclamation mark 502 in the shield are considered as type prompt information corresponding to the alert perception state. As shown in a sub-picture c of FIG. 5, when the second virtual object is in an alert search state, the client displays the shield and a question mark (that is, a state identifier corresponding to the alert search state) in the shield. In this case, the shield and the question mark 503 in the shield are considered as type prompt information corresponding to the alert search state.

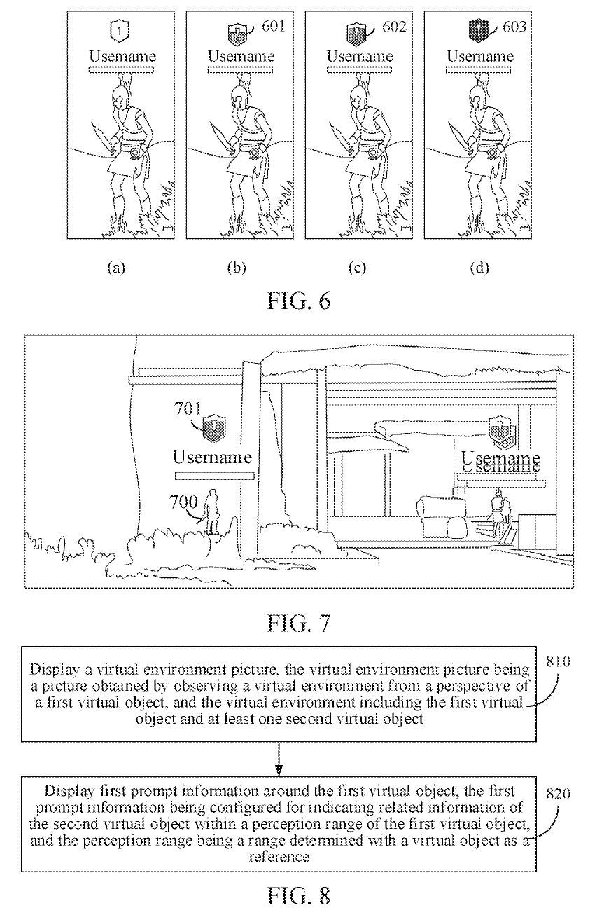

In some embodiments, any of the shields in the sub-graph a, the sub-graph b, or the sub-graph c in FIG. 5 may be considered as a progress bar (that is, a progress identifier), to serve as progress prompt information to indicate alert state progress of the second virtual object. As shown in FIG. 6, alert prompt information 601, alert prompt information 602, and alert prompt information 603 include type prompt information (a shield + an exclamation mark or a single exclamation mark), and further include progress prompt information (a progress bar in a form of a shield). Progresses of alert states respectively indicated in the alert prompt information 601, the alert prompt information 602, and the alert prompt information 603 are different.

In some embodiments, the type prompt information includes an alert state icon, different alert state icons correspond to different alert state types, and the progress prompt information includes a progress bar superimposed on the alert state icon. The progress prompt information may be configured for indicating an alert state progress corresponding to the alert state type corresponding to the alert state icon. In this way, the progress bar configured for indicating the alert state progress and the alert state icon configured for indicating the alert state type are displayed in a superimposed manner, so that an area occupied by the alert prompt information on a user interface can be effectively reduced, thereby improving utilization of the user interface, and ensuring simplicity of the user interface.

For example, as shown in the sub-picture a of FIG. 5, the shield and the level 501 in the shield may also be considered as an alert state icon corresponding to the non-combat state. As shown in the sub-picture b of FIG. 5, the shield and the exclamation mark 502 in the shield may also be considered as an alert state icon corresponding to the alert perception state. As shown in the sub-picture c of FIG. 5, the shield and the question mark 503 in the shield may also be considered as an alert state icon corresponding to the alert search state. As shown in FIG. 6, the progress prompt information is a progress bar superimposed on an alert state icon. In some embodiments, the progress prompt information is a progress bar superimposed on the alert state icon-a shield. In some embodiments, each alert state type corresponds to a different alert state icon, and a specific form of the alert state icon is not limited in this application.

In some embodiments, the different alert state types include at least two of the following: a non-combat state, referring to a state in which no abnormalities in a surrounding environment are perceived; an alert perception state, referring to a state in which an abnormality in a surrounding environment is perceived but a cause of the abnormality is not determined; an alert enhancement state, referring to a state in which an abnormality in a surrounding environment is perceived and a cause of the abnormality is determined; an alert conversion state, referring to a state in which an abnormality in a surrounding environment is perceived and it is determined, based on the determined cause of the abnormality, to switch to a combat state; or an alert search state, referring to a state in which an abnormality in a surrounding environment is perceived and a cause of the abnormality is being searched for. By dividing the alert states into a plurality of different alert state types, representations of the virtual object are diversified, allowing the user to obtain a more accurate alert state, which is conducive to improving gaming experience of the user. In addition, for different alert state types, the user needs to take different measures, thereby improving strategy of the game.

Perceiving an abnormality in a surrounding environment refers to a process of detecting whether an abnormal event occurs within a perception range. The abnormal event includes at least one of the following: a virtual object having a hostile relationship passing by, another virtual object being killed or attacked, a combat occurring, or a plurality of virtual objects appearing. An abnormal event (or a virtual object causing an abnormal event) may be used as a cause of an abnormality. The perception range is a range determined by using the virtual object as a reference, and may be set and adjusted by a designer of an application according to an actual use requirement. This is not limited in this embodiment of this application.

The second virtual object in the alert perception state can perceive an abnormality in the surrounding environment, but does not perceive a specific cause of the abnormality (namely, the cause of the abnormality), which may trigger the second virtual object to engage in behaviors such as searching (namely, a process of searching for the cause of the abnormality). In this case, the alert state type does not affect a behavior of the first virtual object. In other words, the first virtual object can normally perform activities, for example, may continue to assassinate the second virtual object. In some embodiments, the alert perception state may be rolled back. If the second virtual object in the alert perception state still cannot find the cause of the abnormality, the second virtual object rolls back to the non-combat state.

The second virtual object in the alert enhancement state has found the cause of the abnormality, and can locate the cause of the abnormality (which is usually the first virtual object), which may trigger an increase in an angry value of the second virtual object, leading to behaviors such as an attack. In this case, the alert state type affects many behaviors of the first virtual object, that is, a part of activities of the first virtual object are limited, for example, the first virtual object cannot continue to assassinate the second virtual object. In some embodiments, the alert enhancement state cannot be rolled back. The alert state can be caused to disappear only in manners such as expanding a distance from the second virtual object, moving out of a line of sight of the first virtual object, or waiting for a period of time. That is, the second virtual object can be only caused to exit the alert state, but cannot roll back to the alert perception state.

The second virtual object in the alert conversion state switches from the alert state to the combat state. In this case, the second virtual object has completed an entire process of perceiving the abnormality in the surrounding environment and determining the cause of the abnormality, and may change a behavior according to a perception result, to enter the combat state. In this case, the second virtual object determines to attack the first virtual object. In other words, the behavior of the first virtual object is affected by attacks from the second virtual object, to implement switching from the alert state to the combat state. The combat state is not an alert state.

The second virtual object in the alert search state finds the abnormality in the surrounding environment but does not find the cause of the abnormality. The second virtual object enters the alert search state after the alert perception state, to search for the cause of the abnormality in the surrounding environment, and switches to a corresponding state after a search result is obtained. If a corresponding cause is found, the second virtual object switches to the combat state, or if no result is found, the second virtual object switches to the non-combat state.

For example, when the second virtual object detects gunshots, footsteps, and other sounds within a perception range of the second virtual object, it is considered that the second virtual object perceives an abnormality nearby. The second virtual object views, based on control of the server, a point at which an abnormality occurs, but the second virtual object does not necessarily find a cause of the abnormality at the point. When the first virtual object approaches the second virtual object, but uses an item such as a stealth item, the second virtual object cannot find the first virtual object. That is, although the second virtual object perceives the abnormality but does not determine a specific cause of the abnormality, and in this case, the second virtual object rolls back from the alert perception state to the non-combat state. When the second virtual object perceives the abnormality in the surrounding environment and keeps searching for the cause of the abnormality, it is considered that the second virtual object is in the alert search state. When the second virtual object finds the first virtual object, it is considered that the second virtual object determines the cause of the abnormality, and the second virtual object switches to the alert enhancement state. Further, when the second virtual object determines, according to the cause of the abnormality, to switch to the combat state, it is considered that the second virtual object enters the alert conversion state.

For example, as shown in the sub-picture a of FIG. 5, the type prompt information represents that the second virtual object is in the non-combat state. As shown in the sub-picture b of FIG. 5, the type prompt information represents that the second virtual object is in the alert perception state. As shown in the sub-picture c of FIG. 5, the type prompt information represents that the second virtual object is in the alert search state. As shown in a sub-picture a of FIG. 6, the type prompt information represents that the second virtual object is in the non-combat state. As shown in a sub-picture b of FIG. 6, the type prompt information represents that the second virtual object is in the alert perception state. As shown in a sub-picture c of FIG. 6, the type prompt information represents that the second virtual object is in the alert enhancement state. As shown in a sub-picture d of FIG. 6, the type prompt information represents that the second virtual object is in the alert conversion state. In some embodiments, the alert perception state, the alert enhancement state, and the alert conversion state are all represented by a shield and an exclamation mark, but are represented in different colors. For example, a white progress bar and a white shield are used to represent the alert perception state, a yellow progress bar and a yellow shield are used to represent the alert enhancement state, and a red progress bar and a red shield are used to represent the alert conversion state. In some embodiments, progress accumulation or rollback of each type of alert state can switch between alert state types.

FIG. 7 shows that even if a second virtual object 700 is blocked by another virtual object (which is a wall surface), as long as the second virtual object 700 is still within a field of view (which is a capture angle of a virtual camera) a first virtual object, alert prompt information 701 of the second virtual object 700 is still displayed. Certainly, in this case, an outline of the second virtual object 700 may also be displayed, to prompt the first virtual object.

In some embodiments, a quantity of pieces of alert prompt information of the second virtual object that can be displayed in the virtual environment picture and a perception distance of the second virtual object may be determined according to the first virtual object. The perception distance is configured for indicating a perception range, and may be used as a determining criterion for whether the first virtual object falls within a perception range of the second virtual object. For example, if the perception range is a circular area, a radius of the circular area may be the perception distance. A larger perception distance indicates earlier display of alert prompt information.

For example, a quantity of pieces of alert prompt information of the second virtual object that can be displayed in the virtual environment picture and the perception distance of the second virtual object may be determined according to a match level of the first virtual object.

In some embodiments, the match level of the first virtual object may be determined according to historical match information of a user account of the first virtual object, or the match level of the first virtual object may be determined according to a historical score of the user account that controls the first virtual object. This is not limited in this embodiment of this application. In some embodiments, first virtual objects at different match levels correspond to different quantities of pieces of alert prompt information of second virtual objects that can be displayed in the virtual environment picture and have different perception distances for the second virtual object.

For example, when the match level of the first virtual object is low, a larger quantity of pieces of alert prompt information of the second virtual object can be displayed in the virtual environment picture, and a perception distance for the second virtual object is greater. In other words, when the user is a low-level player, by prompting the user with more second virtual objects and making the user perceive the second virtual object from a greater distance, the first virtual object can perceive the second virtual object in advance in all directions, thereby improving match experience of the low-level player.

In some other embodiments, a real battle level of the first virtual object may be determined in real time according to match performance of the first virtual object in a current match. In some embodiments, the quantity of pieces of alert prompt information of the second virtual object that can be displayed in the virtual environment picture and the perception distance for the second virtual object are determined according to the real battle level corresponding to the first virtual object. This considers that when the user controlling the first virtual object is not the usual user of the user account, the skill levels of players in the match may be significantly uneven, which may easily lead to a poor user experience. The real battle level of the first virtual object is determined in real time according to the match performance of the first virtual object in the current match, so that the real battle level of the first virtual object can be learned in time, and a display rule of the alert prompt information can be adjusted in real time. For a high-level player who has better judgment and perception, excessive prompts are unnecessary, meaning that there is no need to display excessive alert prompt information, which is conducive to reducing data transmission overhead, data processing overhead, and data display overhead.

According to the technical solutions provided in this embodiment of this application, alert prompt information of a second virtual object (for example, an AI virtual object) for a first virtual object is displayed in a virtual environment picture, so that a user can quickly obtain and learn an alert state type of the second virtual object and an alert state progress of the second virtual object that are indicated by the alert prompt information, thereby improving information obtaining volume and efficiency. The user can learn in advance, based on the alert state progress, whether the second virtual object is about to switch to another alert state type, so that the user can quickly obtain and learn a state change of a virtual object, to adaptively take a preventive measure in advance, thereby improving human-computer interaction efficiency.

FIG. 8 is a flowchart of a prompt information display method according to another embodiment of this application. Operations of the method may be performed by the terminal device 10 in the solution implementation environment shown in FIG. 1. For example, the operations may be performed by the client of the foregoing target application. In the following method embodiments, for ease of description, an example in which the operations are performed by a "client" is used for description. The method may include at least one of the following several operations (810 and 820).

Operation 810: Display a virtual environment picture, the virtual environment picture being a picture obtained by observing a virtual environment from a perspective of a first virtual object, and the virtual environment including the first virtual object and at least one second virtual object.

Operation 810 is the same as operation 310 described in the foregoing embodiment. For content not described in this embodiment of this application, refer to the foregoing embodiment. Details are not described herein again.

Operation 820: Display first prompt information around the first virtual object, the first prompt information being configured for indicating related information of the second virtual object within a perception range of the first virtual object, and the perception range being a range determined with a virtual object as a reference.

In some embodiments, the around the first virtual object in operation 820 may be considered as an area related to the first virtual object. In some embodiments, the area is a circular area with the first virtual object as a center. In some embodiments, the area is an area in front of the first virtual object. In some embodiments, the area is an area above the head of the first virtual object. Specific areas included in the around the first virtual object are not limited in this embodiment of this application.

In some embodiments, the perception range of the first virtual object may be considered as a field of view of the first virtual object, or may be considered as a circular area with the first virtual object as a center. Considering that the perception range of the first virtual object includes visual perception, and may further include auditory perception and the like, the perception range of the first virtual object may alternatively be determined based on a parameter of the first virtual object. In some embodiments, the perception range of the first virtual object is determined according to a visual parameter, an auditory parameter, and the like of the first virtual object. Certainly, the perception range of the first virtual object may be customized by the user controlling the first virtual object, or may be set by the developer of the application. When the user controlling the first virtual object intends to increase match difficulty, the user may reduce the perception range, or when the user intends to decrease the match difficulty, the user may enlarge the perception range. The perception range is not limited in this embodiment of this application.

In some embodiments, the first prompt information and the foregoing alert prompt information are different prompt information. In some embodiments, the first prompt information is configured for indicating related information of the second virtual object within the perception range of the first virtual object. In some embodiments, the related information of the second virtual object includes at least one of the following: an azimuth of the second virtual object relative to the first virtual object, an alert state type of the second virtual object, an alert state progress of the second virtual object, and a distance between the second virtual object and the first virtual object.

In some embodiments, a manner of indicating the alert state type of the second virtual object and the alert state progress of the second virtual object in the first prompt information is different from a manner of indicating the alert state type of the second virtual object and the alert state progress of the second virtual object in the foregoing alert prompt information. In some embodiments, identifiers of alert state types are different, and display manners of the alert state progress are different. Although a display manner of the first prompt information is different from a display manner of the alert prompt information, for the first prompt information, reference may also be made to the discussions of the alert state type and the alert state progress in the foregoing embodiment. The only difference herein is the display type, and the displayed objects are the same. The alert state type of the second virtual object and the alert state progress of the second virtual object that are indicated in the alert prompt information are in a one-to-one correspondence with the alert state type of the second virtual object and the alert state progress of the second virtual object that are indicated in the first prompt information herein.

In some embodiments, the azimuth of the second virtual object relative to the first virtual object may be determined according to a position of the second virtual object and a position of the first virtual object. In some embodiments, the server determines the azimuth of the second virtual object relative to the first virtual object according to a received position of the second virtual object and a received position of the first virtual object, and sends the azimuth of the second virtual object relative to the first virtual object to the client for displaying by the client.

In some embodiments, the distance between the second virtual object and the first virtual object may be determined according to the position of the second virtual object and the position of the first virtual object. In some embodiments, the server determines the distance between the second virtual object and the first virtual object according to the received position of the second virtual object and the received position of the first virtual object, and sends the distance between the second virtual object and the first virtual object to the client for displaying by the client.

In some embodiments, when the first prompt information is used to indicate the distance between the second virtual object and the first virtual object, there are at least two indication manners. One is to directly use the distance as a quantized value and display the quantized value in the first prompt information. The other is to represent the distance between the second virtual object and the first virtual object according to a display position or a display size of the first prompt information. In some embodiments, when the distance between the second virtual object and the first virtual object is large, the first prompt information is far from the first virtual object, and when the distance between the second virtual object and the first virtual object is small, the first prompt information is close to the first virtual object. In some embodiments, when the distance between the second virtual object and the first virtual object is large, a display font or identifier of the first prompt information is small, and when the distance between the second virtual object and the first virtual object is small, a display font or identifier of the first prompt information is large.

In some embodiments, the first prompt information includes a graphical prompt element corresponding to each second virtual object within the perception range of the first virtual object. A direction of the graphical prompt element may be configured for indicating the azimuth of the second virtual object relative to the first virtual object. A color of the graphical prompt element may be configured for indicating the alert state type of the second virtual object. A length of the graphical prompt element may be configured for indicating the alert state progress of the second virtual object.

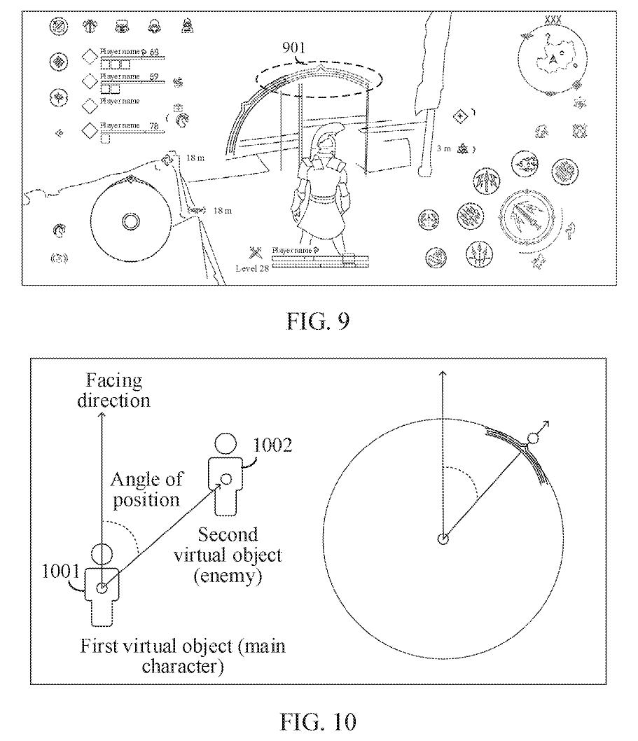

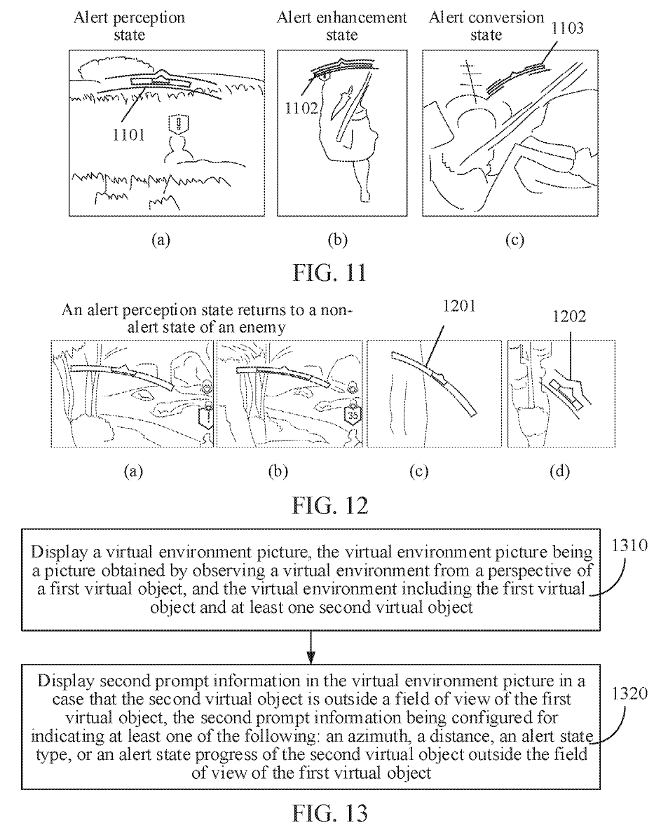

For example, the graphical prompt element is an arc prompt element. For example, as shown in FIG. 9, each graphical prompt element 901 represents first prompt information of one first virtual object, and the graphical prompt element 901 is an arc prompt element. In some embodiments, a direction of the graphical prompt element 901 is configured for indicating an azimuth of a second virtual object relative to a first virtual object. A color of the graphical prompt element 901 is configured for indicating an alert state type of the second virtual object. A length of the graphical prompt element 901 is configured for indicating an alert state progress of the second virtual object. For another example, FIG. 10 shows how to determine an azimuth of a second virtual object 1002 relative to a first virtual object 1001. A relative angle (that is, an angle of a position) between the second virtual object 1002 and the first virtual object 1001 may be determined according to a facing direction of the first virtual object 1001, and the angle is used as the azimuth of the second virtual object 1002 relative to the first virtual object 1001. In some embodiments, dynamic angle changes of +180 degrees and –180 degrees relative to the initial zero-degree direction on the plane may be calculated according to an angle between the positions of the second virtual object 1002 and the first virtual object 1001, and the first prompt information is provided according to the angle.

In some other embodiments, the graphical prompt element 901 shown in FIG. 9 further includes the distance between the second virtual object and the first virtual object. For example, the distance is represented in a value form. In some other embodiments, different graphical prompt elements 901 shown in FIG. 9 may be displayed at different positions according to the distance between the second virtual object and the first virtual object. When the distance between the second virtual object and the first virtual object is large, the graphical prompt element 901 is far from the first virtual object, and when the distance between the second virtual object and the first virtual object is small, the graphical prompt element 901 is close to the first virtual object. When the distance between the second virtual object and the first virtual object is large, a size of the graphical prompt element 901 is small. When the distance between the second virtual object and the first virtual object is small, the size of the graphical prompt element 901 is large.

In some embodiments, different alert state types correspond to different graphical prompt elements. As shown in FIG. 11, different first prompt information is shown. As shown in a sub-picture a of FIG. 11, first prompt information 1101 shown in the figure may be configured for indicating that the second virtual object is in the alert perception state. As shown in a sub-picture b of FIG. 11, first prompt information 1102 shown in the figure may be configured for indicating that the second virtual object is in the alert enhancement state. As shown in a sub-picture c of FIG. 11, first prompt information 1103 shown in the figure may be configured for indicating that the second virtual object is in the alert conversion state. In some embodiments, the graphical prompt element changes with the alert state progress. For example, a sub-picture a, a sub-picture b, a sub-picture c, and a sub-picture d of FIG. 12 show that the first virtual object rolls back from the alert perception state to a non-alert state, a graphical prompt element 1201 corresponding to the alert perception state changes with an alert state progress corresponding to the alert perception state, until finally changes to a graphical prompt element 1202 corresponding to the non-alert state.

According to the technical solutions provided in this embodiment of this application, the first prompt information displayed around the first virtual object is provided, to help the user controlling the first virtual object to quickly perceive the second virtual object. Further, based on the first prompt information, the user may learn the azimuth of the second virtual object relative to the first virtual object, the alert state type of the second virtual object, and the alert state progress of the second virtual object, so that the user can obtain relatively abundant information from the prompt information, which is conducive to improving human-computer interaction efficiency. Further, providing the first prompt information by using the graphical prompt element can improve a perception speed of the user, thereby improving a reaction speed of the user, and further improving gaming experience of the user.

FIG. 13 is a flowchart of a prompt information display method according to another embodiment of this application. Operations of the method may be performed by the terminal device 10 in the solution implementation environment shown in FIG. 1. For example, the operations may be performed by the client of the foregoing target application. In the following method embodiments, for ease of description, an example in which the operations are performed by a "client" is used for description. The method may include at least one of the following several operations (1310 and 1320).

Operation 1310: Display a virtual environment picture, the virtual environment picture being a picture obtained by observing a virtual environment from a perspective of a first virtual object, and the virtual environment including the first virtual object and at least one second virtual object.

Operation 1310 is the same as operation 310 described in the foregoing embodiment. For content not described in this embodiment of this application, refer to the foregoing embodiment. Details are not described herein again.

In some embodiments, alert prompt information is displayed around the second virtual object when the second virtual object is within a field of view of the first virtual object;

The around the second virtual object may be considered as an area related to the second virtual object. In some embodiments, the area is a circular area with the second virtual object as a center. In some embodiments, the area is an area in front of the second virtual object. In some embodiments, the area is an area above the head of the second virtual object. Specific areas included in the around the second virtual object are not limited in this embodiment of this application.

The alert prompt information is alert prompt information of the second virtual object for the first virtual object, and is configured for indicating an alert state type and an alert state progress of the second virtual object for the first virtual object.

Operation 1320: Display second prompt information in the virtual environment picture when the second virtual object is outside the field of view of the first virtual object, the second prompt information being configured for indicating at least one of the following: an azimuth, a distance, the alert state type, or the alert state progress of the second virtual object outside the field of view of the first virtual object.

The second prompt information may be prompt information determined based on the foregoing alert prompt information, which does not need to be displayed around the second virtual object, and may be understood as the alert prompt information of the second virtual object outside the field of view of the first virtual object.

In some embodiments, the second prompt information is prompt information different from the foregoing alert prompt information and first prompt information. In some embodiments, the second prompt information may be configured for indicating the azimuth, the distance, the alert state type, and the alert state progress of the second virtual object outside the field of view of the first virtual object.

The azimuth may be an azimuth of the second virtual object relative to the first virtual object, the distance may be a distance between the second virtual object and the first virtual object, the alert state type may be an alert state type of the second virtual object for the first virtual object, and the alert state progress may be an alert state progress of the second virtual object for the first virtual object.

In some embodiments, as shown in FIG. 4, when the second virtual object 420 cannot be directly seen by the first virtual object 430, it may be determined that the second virtual object 420 is outside the field of view of the first virtual object 430, and the client displays the second prompt information of the second virtual object 420. In some other embodiments, the client displays the second prompt information in the virtual environment picture when the second virtual object is located outside the field of view of the first virtual object (that is, outside an acute-angled sector-shaped area formed by the ray 401 and the ray 402). The second prompt information may be configured for indicating at least one of the azimuth, the distance, the alert state type, or the alert state progress of the second virtual object located outside the field of view of the first virtual object.

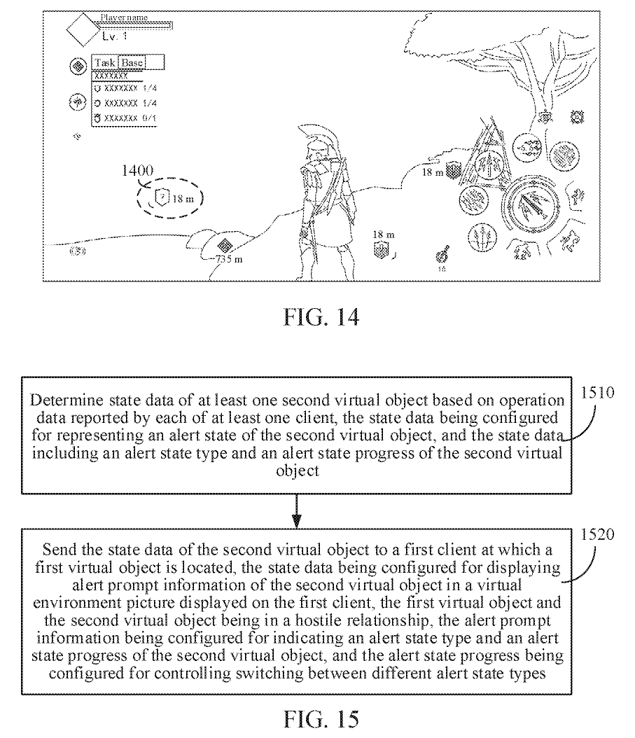

In some embodiments, a specific manner of the second prompt information indicating the azimuth, the distance, the alert state type, and the alert state progress of the second virtual object outside the field of view of the first virtual object is not limited. In some embodiments, a number is used to represent the distance between the second virtual object and the first virtual object, and an arrow is used to represent the azimuth of the second virtual object relative to the first virtual object. Different identifiers are used to represent different alert state types, and different color progresses are used to represent different alert state progress. For example, as shown in FIG. 14, second prompt information 1400 is configured for indicating an azimuth, a distance, an alert state type, and an alert state progress of the second virtual object outside the field of view of the first virtual object (for example, below water). A display position of the second prompt information is also not limited in this embodiment of this application. In some embodiments, the second prompt information is displayed at an edge of the virtual environment picture when the second virtual object is outside the field of view of the first virtual object. The second prompt information may alternatively be displayed on a connection line between positions of the first virtual object and the second virtual object.

In some embodiments, when the first virtual object leaves a perception range of the second virtual object, the alert state type and the alert state progress of the second virtual object continue to be updated. This embodiment of this application may further include the following content. Within a first time period after the first virtual object leaves the perception range of the second virtual object, if a third virtual object enters the perception range of the second virtual object at a first moment, alert prompt information of the second virtual object for the third virtual object continues to be updated starting from an alert state type and an alert state progress at the first moment.

In some embodiments, the third virtual object and the first virtual object have a hostile relationship. The first time period may be set and adjusted according to an actual use requirement, and the first moment is configured for indicating a moment at which the third virtual object enters the perception range of the second virtual object. After the foregoing condition is satisfied, the third virtual object may inherit the alert prompt information of the second virtual object for the first virtual object.

For example, when the first virtual object is the only cause for the change in the alert state of the second virtual object, when the first virtual object leaves the perception range of the second virtual object, the alert state type and the alert state progress of the second virtual object continuous to be updated. That is, the second virtual object does not directly exit the alert state, and there is a rollback process of exiting the alert state. For example, the alert state progress of the second virtual object may roll back. Whether to roll back to a next alert state type may be determined by detecting whether there is another cause of the alert of the second virtual object within a threshold time. If there is no other cause, after the threshold time is satisfied, the alert state progress of the second virtual object is controlled to continue to roll back, until the alert state progress of the second virtual object rolls back to the non-combat state. In some embodiments, in a rollback process of the alert state progress and the alert state type, if the third virtual object enters the perception range of the second virtual object, the second virtual object is controlled to stop the rollback of the alert state progress, and the alert state type and the alert state progress of the second virtual object are determined again according to the alert state type and the alert state progress of the second virtual object at a moment at which the third virtual object enters the perception range of the second virtual object, so that the third virtual object inherits the alert prompt information of the second virtual object for the first virtual object.

In some embodiments, when the first virtual object satisfies a condition of breaking away from the alert of the second virtual object, the alert state type and the alert state progress of the second virtual object continue to be updated. Within the first time period after the first virtual object breaks away from the alert of the second virtual object, if the third virtual object having the hostile relationship with the second virtual object enters the perception range of the second virtual object at the first moment, the alert prompt information of the second virtual object for the third virtual object is controlled to continue to be updated starting from the alert state type and the alert state progress of the first moment.

In some embodiments, the foregoing condition of breaking away from the alert of the second virtual object includes, but is not limited to, at least one of the following: the first virtual object being not within a field of view of the second virtual object, the distance between the first virtual object and the second virtual object being greater than a threshold, the first virtual object being dead, or the first virtual object using an item (such as a stealth item). When the first virtual object satisfies the condition of breaking away from the alert of the second virtual object, the first virtual object is no longer the cause of the alert of the second virtual object. In this case, the alert state type of the second virtual object rolls back, and during the rollback process, if there is no other cause of the alert, the second virtual object rolls back to the non-combat state. If another cause of the alert appears during the rollback process, the alert state type and the alert state progress of the second virtual object are recalculated from a moment at which the another cause of the alert appears.

In some embodiments, the perception range of the second virtual object may be set by a user account corresponding to the first virtual object, or may be designed by the developer of the application. In some embodiments, when the user may change the perception range of the second virtual object, the perception range may be changed in real time during a game match, or may be changed in advance outside a game match. This is not limited in this embodiment of this application.

In this embodiment of this application, inheritance (also referred to as enemy inheritance) of the alert state of the second virtual object is implemented. The enemy inheritance can enhance experience of the user in the virtual environment. Specifically, even if an alert of the enemy is triggered by another player (the third virtual object), when a current user (the first virtual object) happens to pass by, the enemy may still attack the first virtual object, thereby enhancing realism of the virtual environment.

In addition, when the second virtual object is located outside the field of view of the first virtual object, the second prompt information is displayed to indicate the azimuth, the distance, the alert state type, and the alert state progress of the second virtual object, which is conducive to diversifying display content of the prompt information and display forms of the prompt information, thereby enhancing human-computer interaction.

The technical solutions provided in the embodiments of this application are exemplarily described below from the perspective of a server.

FIG. 15 is a flowchart of a prompt information display method according to another embodiment of this application. Operations of the method may be performed by the server 20 in the solution implementation environment shown in FIG. 1. For example, the operations may be performed by a server of the foregoing target application. In the following method embodiments, for ease of description, an example in which the operations are performed by a "server" is used for description. The method may include at least one of the following several operations (1510 and 1520).

Operation 1510: Determine state data of at least one second virtual object based on operation data reported by each of at least one client, the state data being configured for representing an alert state of the second virtual object, and the state data including an alert state type and an alert state progress of the second virtual object.

In some embodiments, the server receives the operation data reported by each of the at least one client, and determines environmental data corresponding to a perception range of the second virtual object; matches the environmental data with a state rule library corresponding to the second virtual object, where the state rule library records a state achievement condition and a state progress change condition that correspond to each of at least one alert state type; when the environmental data satisfies a state achievement condition corresponding to a target alert state type in the state rule library, determines the target alert state type as the alert state type of the second virtual object; determine an alert state progress of the second virtual object according to the environmental data and a state progress change condition corresponding to the target alert state type; and determines the state data of the second virtual object according to the alert state type of the second virtual object and the alert state progress of the second virtual object.

The state data may be data configured for describing a state of a virtual object. In this embodiment of this application, the state data may be data configured for describing an alert state of a second virtual object. For example, the state data includes data configured for describing an alert state type and an alert state progress of a second virtual object (that is, the data configured for describing the alert prompt information).

The operation data may be data generated by an operation of a user. In some embodiments, the operation data includes an operation performed by the user, a position of a virtual object controlled by the user, a posture of the virtual object, and the like. In some embodiments, each client corresponding to the virtual environment needs to report the operation data to the server. In some embodiments, the server determines, according to the operation data and a perception range of each second virtual object, environmental data corresponding to the perception range of the second virtual object.

The environmental data is data configured for describing a virtual environment. For example, the environmental data corresponding to the perception range of the second virtual object is configured for describing a virtual environment within the perception range of the second virtual object. In some embodiments, the environmental data includes a series of data configured for describing whether there is another virtual object, a position of another virtual object, whether there is an abnormal sound, and the like. Matching is performed between the environmental data and a state rule library corresponding to the second virtual object. The state rule library records a state achievement condition and a state progress change condition corresponding to each of at least one alert state. The state achievement condition is a condition of changing to an alert state of a specific type, and the state progress change condition is a condition that causes the alert state type to change. For example, a condition for the second virtual object to enter the alert perception state is that at least one other virtual object exists within the perception range of the second virtual object. When it is determined, according to the environmental data, that there is the at least one other virtual object within the perception range of the second virtual object, the server determines the alert state type of the second virtual object as the alert perception state; determines the alert state progress of the second virtual object according to the environmental data and a state progress change condition corresponding to a target alert state (for example, the alert state progress is controlled to correspondingly increase according to time for which another virtual object stays within the perception range of the second virtual object); and determines the state data of the second virtual object according to the alert state type of the second virtual object and the alert state progress of the second virtual object. The target alert state type may be any alert state type corresponding to the alert state.

In some embodiments, the alert state is managed by an underlying layer of an enemy AI state. For example, a value is obtained by using an AI behavior tree to manage the alert state. In some embodiments, different behaviors of the virtual object controlled by the user may cause an enemy (namely, the second virtual object) to generate different alert values. A corresponding reaction is invoked from a reaction library of the enemy by using the alert value for execution. This is also referred to as a state management mechanism of an underlying layer of the second virtual object. The state management mechanism includes various condition libraries and corresponding reaction mechanism libraries activated after the enemy enters an alert state, and controls, with reference to various reasons (for example, a behavior of the first virtual object), the enemy to make various behaviors such as alert, combat, ignore, and patrol.

Operation 1520: Send the state data of the second virtual object to a first client at which the first virtual object is located, the state data being configured for displaying alert prompt information of the second virtual object in a virtual environment picture displayed on the first client. The first virtual object and the second virtual object are in a hostile relationship, the alert prompt information is configured for indicating an alert state type and an alert state progress of the second virtual object, and the alert state progress is configured for controlling switching between different alert state types.

The first client displays and updates alert prompt information of the second virtual object in the virtual environment according to the state data, and controls, according to the state data, the second virtual object to make a corresponding reaction behavior to a behavior of the first virtual object. In some embodiments, different alert state types are configured for indicating different reactions of the second virtual object to the first virtual object.

In some embodiments, when the first virtual object leaves the perception range of the second virtual object, the server continues to update the alert state type and the alert state progress of the second virtual object. Within a first time period after the first virtual object leaves the perception range of the second virtual object, if a third virtual object having the hostile relationship with the second virtual object enters the perception range of the second virtual object at a first moment, the alert prompt information of the second virtual object for the third virtual object is controlled to continue to be updated starting from an alert state type and an alert state progress at the first moment.

For content not described in this embodiment of this application, refer to the foregoing embodiments (for example, the embodiment of a terminal side). Details are not described herein again.

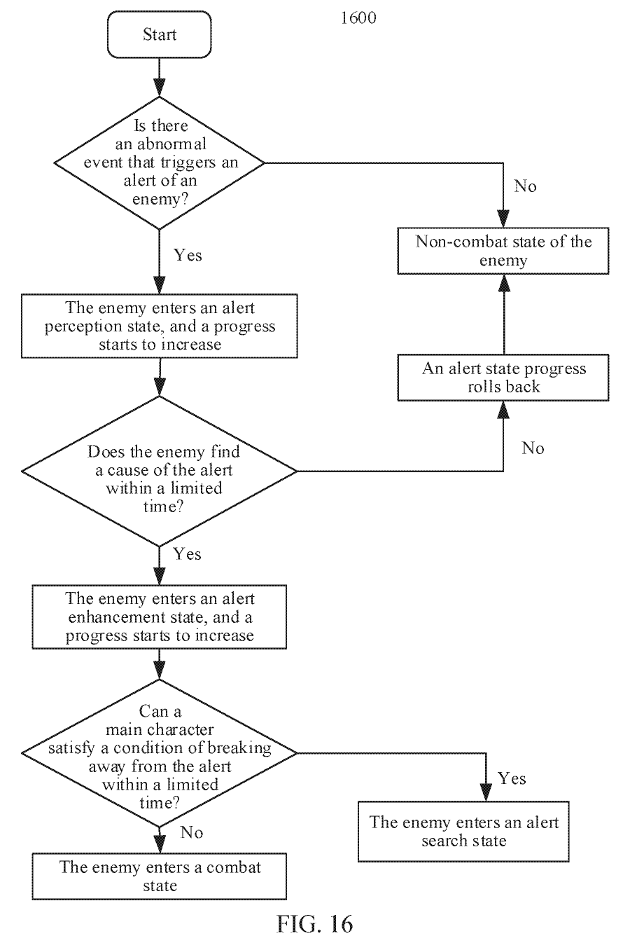

FIG. 16 is a block diagram of a method for determining an alert state type according to an embodiment of this application. Operations of the method may be performed by the terminal device 10 in the solution implementation environment shown in FIG. 1 or may be performed by the server 20 in the implementation environment shown in FIG. 1. For example, the operations may be performed by the client or a backend server of the foregoing target application. In the following method embodiments, for ease of description, that each operation is performed by a "computer device" is used for description.

In some embodiments, as shown in a block diagram 1600 of FIG. 16, whether there is an abnormal event triggering an alert of an enemy is first determined, and if there is an abnormal event triggering the alert of the enemy, the enemy is controlled to enter an alert perception state, and an alert state progress corresponding to the alert perception state starts to increase. If there is no abnormal event triggering the alert of the enemy, the enemy is controlled to enter a non-combat state. After the enemy enters the alert perception state, whether the enemy can find a cause of the alert within a limited time is determined. If the enemy can find the cause of the alert, the enemy is controlled to enter an alert enhancement state. If the enemy cannot find the cause of the alert, the alert state progress is controlled to roll back to a non-combat state. After the enemy enters the alert enhancement state, the alert state progress corresponding to the alert enhancement state starts to increase. Whether a main character (for example, the first virtual object) can satisfy a condition of breaking away from alert within a limited time is determined. If the main character can break away from the alert, the enemy is controlled to switch to a combat state, and if the main character cannot break away from the alert, the enemy is controlled to enter an alert search state. Conditions of triggering the alert include: hearing footsteps nearby (a volume of the footsteps reaches a value), a corpse appearing within a patrol range of an enemy, seeing a virtual object controlled by a player passing by, and the like. Conditions of breaking away from the alert include: moving out of sight, increasing a distance, crouching to reduce noise, finding a hidden bush to distance oneself, and the like.

In this embodiment of this application, the enemy may be the second virtual object, and the main character may be the first virtual object.

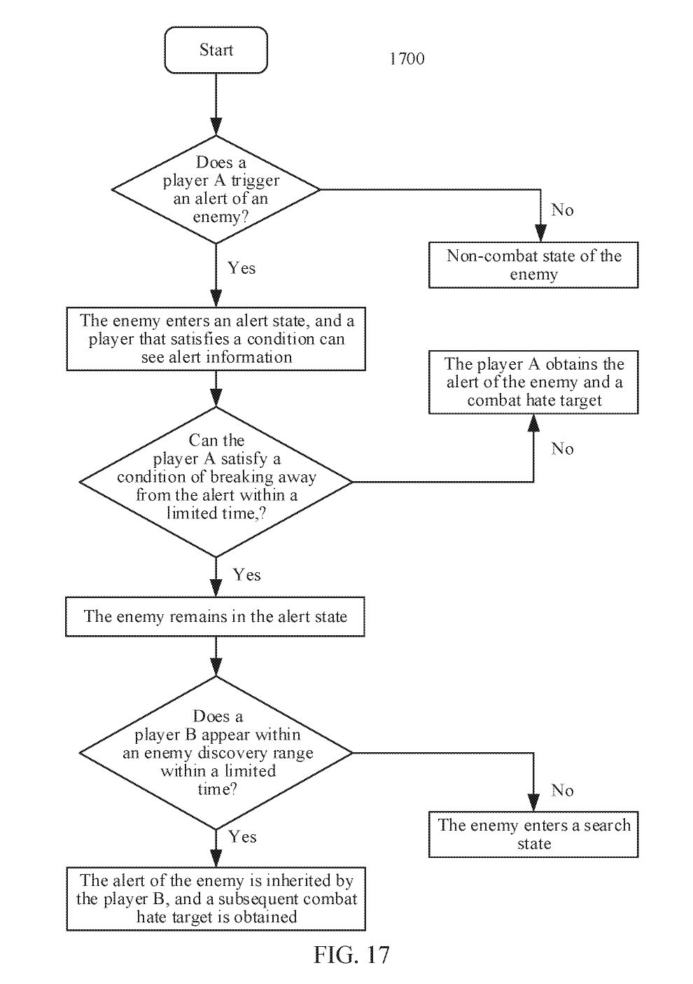

FIG. 17 is a block diagram of a method for inheriting an alert state according to an embodiment of this application. Operations of the method may be performed by the terminal device 10 in the solution implementation environment shown in FIG. 1 or may be performed by the server 20 in the implementation environment shown in FIG. 1. For example, the operations may be performed by the client or a backend server of the foregoing target application. In the following method embodiments, for ease of description, that each operation is performed by a "computer device" is used for description.

In some embodiments, as shown in a block diagram 1700 of FIG. 17, whether a player A triggers an alert of an enemy is determined, and if the player A triggers the alert of the enemy, the enemy is controlled to enter an alert state, and a player satisfying the condition can see alert prompt information. If the player A does not trigger the alert of the enemy, the enemy is controlled to be in a non-combat state. Whether the player A can satisfy the condition of breaking from the alert within a limited time continues to be determined. If the player A can satisfy the condition of breaking away from the alert within the limited time, the enemy is controlled to remain in the alert state. If the player A cannot satisfy the condition of breaking away from the alert within the limited time, it is determined that the player A obtains the alert of the enemy and a combat hate target. If the enemy remains in the alert state (in some embodiments, regardless whether the player A breaks away from the perception range of the enemy), it is determined whether there is a player B in an enemy discovery range (the perception range) within the limited time, and if there is the player B within the enemy discovery range, it is determined that the alert of the enemy is inherited by the player B, and a subsequent combat hate target is obtained; or if there is no player B within the enemy discovery range, the enemy is controlled to enter an alert search state. This embodiment of this application completely presents a detailed process of an alert state change of the enemy, and can implement state inheritance from the player A to the player B in a multiplayer gameplay mode.

In this embodiment of this application, the enemy may be the second virtual object, the player A may be the first virtual object, and the player B may be the third virtual object.

According to the technical solutions provided in this embodiment of this application, alert prompt information of a second virtual object (for example, an AI virtual object) for a first virtual object is displayed in a virtual environment picture, so that a user can quickly obtain and learn an alert state type of the second virtual object and an alert state progress of the second virtual object that are indicated by the alert prompt information, thereby improving information obtaining volume and efficiency. The user can learn in advance, based on the alert state progress, whether the second virtual object is about to switch to another alert state type, so that the user can quickly obtain and learn a state change of a virtual object, to adaptively take a preventive measure in advance, thereby improving human-computer interaction efficiency.

The following is an apparatus embodiment of this application, which may be configured to perform the method embodiments of this application. For details not disclosed in the apparatus embodiment of this application, refer to the method embodiments of this application.

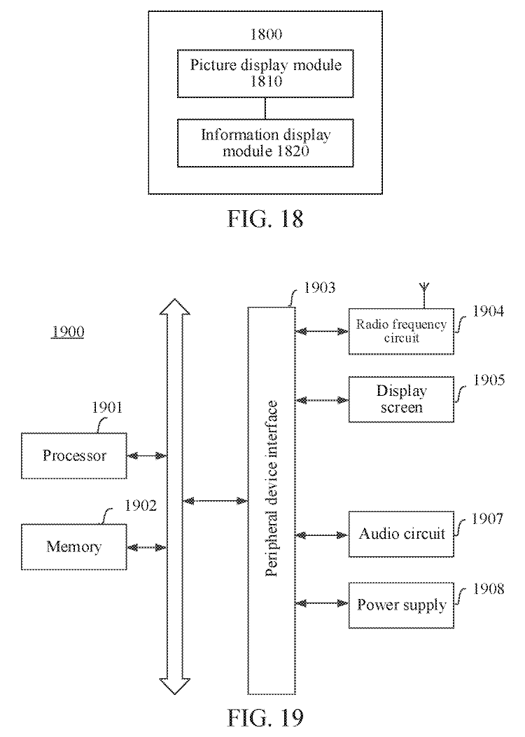

FIG. 18 is a block diagram of a prompt information display apparatus according to an embodiment of this application. The apparatus has functions of implementing the foregoing method examples. The functions may be implemented by hardware, or may be implemented by hardware executing corresponding software. The apparatus may be the terminal device described above, or may be disposed in the terminal device. As shown in FIG. 18, the apparatus 1800 may include: a picture display module 1810 and an information display module 1820.

The picture display module 1810 is configured to display a virtual environment picture, the virtual environment picture being a picture obtained by observing a virtual environment from a perspective of a first virtual object, and the virtual environment including the first virtual object and at least one second virtual object.

The information display module 1820 is configured to display, in the virtual environment picture, alert prompt information of the second virtual object for the first virtual object, the alert prompt information being configured for indicating an alert state type and an alert state progress of the second virtual object, the alert state progress being configured for controlling switching between different alert state types, and the different alert state types being configured for indicating different reactions of the second virtual object to the first virtual object.

In some embodiments, the alert prompt information includes: type prompt information, configured for indicating the alert state type of the second virtual object; and progress prompt information, configured for indicating the alert state progress of the second virtual object.

In some embodiments, the type prompt information includes an alert state icon, different alert state icons correspond to different alert state types, and the progress prompt information includes a progress bar superimposed on the alert state icon.

In some embodiments, the different alert state types include at least two of the following: a non-combat state, referring to a state in which no abnormalities in a surrounding environment are perceived; an alert perception state, referring to a state in which an abnormality in a surrounding environment is perceived but a cause of the abnormality is not determined; an alert enhancement state, referring to a state in which an abnormality in a surrounding environment is perceived and a cause of the abnormality is determined; an alert conversion state, referring to a state in which an abnormality in a surrounding environment is perceived and it is determined, based on the determined cause of the abnormality, to switch to a combat state; or an alert search state, referring to a state in which an abnormality in a surrounding environment is perceived and a cause of the abnormality is being searched for.

In some embodiments, the information display module 1820 is further configured to display first prompt information around the first virtual object, the first prompt information being configured for indicating related information of the second virtual object within a perception range of the first virtual object, and the perception range being a range determined with a virtual object as a reference.

In some embodiments, the related information of the second virtual object includes at least one of the following: an azimuth of the second virtual object relative to the first virtual object; the alert state type of the second virtual object; or the alert state progress of the second virtual object.

In some embodiments, the first prompt information includes a graphical prompt element corresponding to each second virtual object within the perception range of the first virtual object, where a direction of the graphical prompt element is configured for indicating the azimuth of the second virtual object relative to the first virtual object; a color of the graphical prompt element is configured for indicating the alert state type of the second virtual object; and a length of the graphical prompt element is configured for indicating the alert state progress of the second virtual object.

In some embodiments, the information display module 1820 is further configured to:

display the alert prompt information around the second virtual object when the second virtual object is within a field of view of the first virtual object; or

display second prompt information in the virtual environment picture when the second virtual object is outside the field of view of the first virtual object, the second prompt information being configured for indicating at least one of the following: an azimuth, a distance, the alert state type, or the alert state progress of the second virtual object outside the field of view of the first virtual object.

In some embodiments, when the first virtual object leaves the perception range of the second virtual object, the alert state type and the alert state progress of the second virtual object continue to be updated. The information display module 1820 is further configured to: within a first time period after the first virtual object leaves the perception range of the second virtual object, if a third virtual object enters the perception range of the second virtual object at a first moment, continue to update alert prompt information of the second virtual object for the third virtual object starting from an alert state type and an alert state progress at the first moment.

According to the technical solutions provided in this embodiment of this application, alert prompt information of a second virtual object (for example, an AI virtual object) for a first virtual object is displayed in a virtual environment picture, so that a user can quickly obtain and learn an alert state type of the second virtual object and alert state progress of the second virtual object that are indicated by the alert prompt information, thereby improving information obtaining volume and efficiency. The user can learn in advance, based on the alert state progress, whether the second virtual object is about to switch to another alert state type, so that the user can quickly obtain and learn a state change of a virtual object, to adaptively take a preventive measure in advance, thereby improving human-computer interaction efficiency.

When the apparatus provided in the foregoing embodiment of this application implements the functions of the apparatus, division of the foregoing functional modules is merely used as an example for description. In practical applications, the functions may be allocated to and completed by different functional modules according to requirements. That is, an internal structure of the apparatus is divided into different functional modules, to complete all or some of the functions described above. In addition, the apparatus provided in the foregoing embodiment belong to the same concept as the method embodiment. For details of a specific implementation of the apparatus, refer to the method embodiments. Details are not described herein again.

FIG. 19 is a block diagram of a terminal device 1900 according to an embodiment of this application. The terminal device 1900 may be a terminal device 10 in the implementation environment shown in FIG. 1, and is configured to implement the prompt information display method according the foregoing embodiments. Specifically,

the terminal device 1900 generally includes: a processor 1901 and a memory 1902.

The processor 1901 may include one or more processing cores, such as a 4-core processor or an 8-core processor. The processor 1901 may be implemented by using at least one hardware form of a digital signal processor (DSP), a field programmable gate array (FPGA), and a programmable logic array (PLA). The processor 1901 may also include a main processor and a coprocessor. The main processor is configured to process data in an awake state, also referred to as a central processing unit (CPU). The coprocessor is a low-power processor configured to process data in a standby state. In some embodiments, the processor 1901 may be integrated with a graphics processing unit (GPU). The GPU is configured to be responsible for rendering and drawing content that a display screen needs to display. In some embodiments, the processor 1901 may further include an AI processor. The AI processor is configured to process computing operations related to machine learning.

The memory 1902 may include one or more computer-readable storage media. The computer-readable storage medium may be non-transitory. The memory 1902 may further include a high-speed random access memory and a non-volatile memory, for example, one or more disk storage devices or flash storage devices. In some embodiments, the non-transitory computer-readable storage medium in the memory 1902 is configured to store a computer program. The computer program is configured to be executed by one or more processors, to implement the foregoing prompt information display method.

In some embodiments, the terminal device 1900 may exemplarily include: a peripheral device interface 1903 and at least one peripheral device. The processor 1901, the memory 1902, and the peripheral device interface 1903 may be connected through a bus or a signal cable. Each peripheral device may be connected to the peripheral device interface 1903 through a bus, a signal cable, or a circuit board. Specifically, the peripheral device includes: at least one of a radio frequency circuit 1904, a display screen 1905, an audio circuit 1907, or a power supply 1908.

A person skilled in the art may understand that the structure shown in FIG. 19 constitutes no limitation on the terminal device 1900, and the terminal may include more or fewer components than those shown in the figure, or some components may be combined, or a different component deployment may be used.

In an exemplary embodiment of this application, a non-transitory computer-readable storage medium is further provided. The computer-readable storage medium has a computer program stored therein. The computer program, when executed by a processor, implements the prompt information display method.

In some embodiments, the computer-readable storage medium may include: a read-only memory (ROM), a random access memory (RAM), a solid state drive (SSD), an optical disc, or the like. The random access memory may include a resistive random access memory (ReRAM) and a dynamic random access memory (DRAM).

In an exemplary embodiment, a computer program product is provided. The computer program product includes computer instructions, and the computer instructions are stored in a non-transitory computer-readable storage medium. A processor of a terminal device reads the computer instructions from the computer-readable storage medium and executes the computer instructions to cause the computer device to perform the prompt information display method.

In this application, before relevant user data is collected and in a process of collecting the relevant user data, a prompt interface or a pop-up window may be displayed, or voice prompt information may be outputted. The prompt interface, the pop-up window, or the voice prompt information is configured for prompting the user that the user relevant data is currently being collected, so that in this application, relevant steps of obtaining the relevant user data start being performed only after a confirmation operation performed by the user on the prompt interface or the pop-up window is obtained; otherwise (that is, when the confirmation operation performed by the user on the prompt interface or the pop-up window is not obtained), the relevant steps of obtaining the relevant user data are terminated, that is, the user relevant data is not obtained. In other words, all user data collected by this application is processed strictly in accordance with the requirements of relevant national laws and regulations. The informed consent or separate consent of a personal information subject is collected with the consent and authorization of the user, subsequent data use and processing activities are carried out within the scope of laws, regulations and the authorization of the personal information subject, and the collection, use and processing of relevant user data need to comply with relevant laws, regulations and standards of relevant countries and regions. For example, the virtual environment, the operation data, the user account, and the like involved in this application are all obtained under full authorization.

"Plurality of" mentioned in this specification means two or more. The term "and/or" describes an association relationship between associated objects and represents that three relationships may exist. For example, A and/or B may represent the following three cases: Only A exists, both A and B exist, and only B exists. The character "/" generally indicates an "or" relationship between the associated objects. In addition, the step numbers described in this specification merely exemplarily show a possible performing sequence of the steps. In some other embodiments, the steps may not be performed according to the number sequence. For example, two steps with different numbers may be performed simultaneously, or two steps with different numbers may be performed according to a sequence contrary to the sequence shown in the figure. This is not limited in the embodiments of this application.

The foregoing descriptions are merely exemplary embodiments of this application, but are not intended to limit this application. Any modification, equivalent replacement, or improvement made within the spirit and principle of this application shall fall within the protection scope of this application.

What is claimed is:

1. A prompt information display method performed by a computer device, the method comprising:
displaying a picture of a virtual environment, and the virtual environment comprising the first virtual object and at least one second virtual object; and
updating the virtual environment picture with alert prompt information of the second virtual object for the first virtual object, the alert prompt information being configured for indicating an alert state type and an alert state progress of the second virtual object, the alert state progress being configured for controlling switching between different alert state types indicating different reactions of the second virtual object to the first virtual object.

2. The method according to claim 1, wherein the alert prompt information comprises:
type prompt information, configured for indicating the alert state type of the second virtual object; and
progress prompt information, configured for indicating the alert state progress of the second virtual object.

3. The method according to claim 2, wherein the type prompt information comprises an alert state icon, different alert state icons correspond to different alert state types, and the progress prompt information comprises a progress bar superimposed on the alert state icon.

4. The method according to claim 1, wherein the different alert state types comprise at least two of the following:
a non-combat state, referring to a state in which no abnormalities in a surrounding environment are perceived;
an alert perception state, referring to a state in which an abnormality in a surrounding environment is perceived but a cause of the abnormality is not determined;
an alert enhancement state, referring to a state in which an abnormality in a surrounding environment is perceived and a cause of the abnormality is determined;
an alert conversion state, referring to a state in which an abnormality in a surrounding environment is perceived and it is determined, based on the determined cause of the abnormality, to switch to a combat state; and
an alert search state, referring to a state in which an abnormality in a surrounding environment is perceived and a cause of the abnormality is being searched for.

5. The method according to claim 1, further comprising:
displaying first prompt information around the first virtual object, the first prompt information indicating related information of the second virtual object within a perception range of the first virtual object.

6. The method according to claim 5, wherein the related information of the second virtual object comprises at least one of the following:
an azimuth of the second virtual object relative to the first virtual object;
the alert state type of the second virtual object; and
the alert state progress of the second virtual object.

7. The method according to claim 5, wherein the first prompt information comprises a graphical prompt element corresponding to each second virtual object within the perception range of the first virtual object,
a direction of the graphical prompt element being configured for indicating the azimuth of the second virtual object relative to the first virtual object;
a color of the graphical prompt element is configured for indicating the alert state type of the second virtual object; and
a length of the graphical prompt element is configured for indicating the alert state progress of the second virtual object.

8. The method according to claim 1, further comprising:
displaying the alert prompt information around the second virtual object when the second virtual object is within a field of view of the first virtual object; and
displaying second prompt information in the virtual environment picture when the second virtual object is outside the field of view of the first virtual object, the second prompt information being configured for indicating at least one of the following: an azimuth, a distance, the alert state type, or the alert state progress of the second virtual object outside the field of view of the first virtual object.

9. The method according to claim 1, wherein when the first virtual object leaves a perception range of the second virtual object, the alert state type and the alert state progress of the second virtual object continue to be updated; and the method further comprises:
when a third virtual object enters the perception range of the second virtual object at a first moment after the first virtual object leaves the perception range of the second virtual object, continuing to update alert prompt information of the second virtual object for the third virtual object starting from an alert state type and an alert state progress at the first moment.

10. A computer device, comprising a processor and a memory, the memory having a computer program stored therein, and the computer program being loaded and executed by the processor and causing the computer device to implement a prompt information display method including:
displaying a picture of a virtual environment, and the virtual environment comprising the first virtual object and at least one second virtual object; and
updating the virtual environment picture with alert prompt information of the second virtual object for the first virtual object, the alert prompt information being configured for indicating an alert state type and an alert state progress of the second virtual object, the alert state progress being configured for controlling switching between different alert state types indicating different reactions of the second virtual object to the first virtual object.

11. The computer device according to claim 10, wherein the alert prompt information comprises:
type prompt information, configured for indicating the alert state type of the second virtual object; and
progress prompt information, configured for indicating the alert state progress of the second virtual object.

12. The computer device according to claim 11, wherein the type prompt information comprises an alert state icon, different alert state icons correspond to different alert state types, and the progress prompt information comprises a progress bar superimposed on the alert state icon.

13. The computer device according to claim 10, wherein the different alert state types comprise at least two of the following:
a non-combat state, referring to a state in which no abnormalities in a surrounding environment are perceived;
an alert perception state, referring to a state in which an abnormality in a surrounding environment is perceived but a cause of the abnormality is not determined;
an alert enhancement state, referring to a state in which an abnormality in a surrounding environment is perceived and a cause of the abnormality is determined;
an alert conversion state, referring to a state in which an abnormality in a surrounding environment is perceived and it is determined, based on the determined cause of the abnormality, to switch to a combat state; and
an alert search state, referring to a state in which an abnormality in a surrounding environment is perceived and a cause of the abnormality is being searched for.

14. The computer device according to claim 10, wherein the method further comprises:
displaying first prompt information around the first virtual object, the first prompt information indicating related information of the second virtual object within a perception range of the first virtual object.

15. The computer device according to claim 10, wherein the method further comprises:
displaying the alert prompt information around the second virtual object when the second virtual object is within a field of view of the first virtual object; and
displaying second prompt information in the virtual environment picture when the second virtual object is outside the field of view of the first virtual object, the second prompt information being configured for indicating at least one of the following: an azimuth, a distance, the alert state type, or the alert state progress of the second virtual object outside the field of view of the first virtual object.

16. The computer device according to claim 10, wherein when the first virtual object leaves a perception range of the second virtual object, the alert state type and the alert state progress of the second virtual object continue to be updated; and the method further comprises:
when a third virtual object enters the perception range of the second virtual object at a first moment after the first virtual object leaves the perception range of the second virtual object, continuing to update alert prompt information of the second virtual object for the third virtual object starting from an alert state type and an alert state progress at the first moment.

17. A nontransitory computer-readable storage medium, having a computer program stored therein, the computer program being loaded and executed by a processor of a computer device and causing the computer device to implement a prompt information display method including:
displaying a picture of a virtual environment, and the virtual environment comprising the first virtual object and at least one second virtual object; and
updating the virtual environment picture with alert prompt information of the second virtual object for the first virtual object, the alert prompt information being configured for indicating an alert state type and an alert state progress of the second virtual object, the alert state progress being configured for controlling switching between different alert state types indicating different reactions of the second virtual object to the first virtual object.

18. The nontransitory computer-readable storage medium according to claim 17, wherein the alert prompt information comprises:
type prompt information, configured for indicating the alert state type of the second virtual object; and
progress prompt information, configured for indicating the alert state progress of the second virtual object.

19. The nontransitory computer-readable storage medium according to claim 17, wherein the different alert state types comprise at least two of the following:
a non-combat state, referring to a state in which no abnormalities in a surrounding environment are perceived;
an alert perception state, referring to a state in which an abnormality in a surrounding environment is perceived but a cause of the abnormality is not determined;
an alert enhancement state, referring to a state in which an abnormality in a surrounding environment is perceived and a cause of the abnormality is determined;
an alert conversion state, referring to a state in which an abnormality in a surrounding environment is perceived and it is determined, based on the determined cause of the abnormality, to switch to a combat state; and
an alert search state, referring to a state in which an abnormality in a surrounding environment is perceived and a cause of the abnormality is being searched for.

20. The nontransitory computer-readable storage medium according to claim 17, wherein the method further comprises:
displaying first prompt information around the first virtual object, the first prompt information indicating related information of the second virtual object within a perception range of the first virtual object.
